(19) United States
(12) Patent Application Publication
(10) Pub. No.: US 2014/0081599 A1
(43) Pub. Date: Mar. 20, 2014

(54) VISUALIZING DIMENSIONS AND USAGE OF A SPACE

(71) Applicant: Josh Bradley, Wilsonville, OR (US)

(72) Inventor: Josh Bradley, Wilsonville, OR (US)

(21) Appl. No.: 13/622,948

(22) Filed: Sep. 19, 2012

(51) Int. Cl. G06F 17/50

(52) U.S. Cl. CPC G06F 17/5004
USPC 703/1

(57) ABSTRACT

Technologies and implementations for determining one or more dimensions of a space and/or object and visualizing usage of space are generally disclosed.

### BACKGROUND

When remodeling, redecorating, or purchasing a new home, it may be helpful to visualize the usage of space (e.g., positioning of furniture within a room, or the like). Particularly, it may be helpful to visualize the usage of space without needing to place objects (e.g., furniture, or the like) in the space or measure all aspects of the space and the objects to be placed in the space. For example, it may be helpful to determine whether a particular set of bedroom furniture may fit within a bedroom prior to purchasing the furniture set. Furthermore, it may be helpful to visualize the positioning of the furniture within the room.

Conventionally, measuring tools (e.g., tape measures, rulers, or the like) are needed to measure the space as well as the objects to be placed in the space. Additionally, scale models may be built to visualize the arrangements of objects within a space. However, as will be appreciated, using measuring tools often takes some planning (e.g., measuring the space before hand, or the like). Furthermore, using measuring tools may be susceptible to error. In addition, building scale models is time consuming and/or expensive and may not be practical for all purposes.

### SUMMARY

In general, the present disclosure is drawn, inter alia, to methods and apparatuses for visualizing objects within a space. In some embodiments of the present disclosure, dimensions of a space and/or objects may be determined from images (e.g., photographs, or the like) of the space and/or objects. Additionally, in some embodiments, a visual representation of a space including some objects that may not be currently present in the space may be generated. For example, a visual representation of a room may be generated. As part of the representation, furniture (e.g., a couch, or the like) that may not be shown in the room, may be shown in the visual representation as being in the room.

Example method may include determining one or more dimensions of a space, receiving a first image portraying a first object, determining one or more dimensions of the first object, and providing an indication of whether the first object will fit within the space based at least in part on the determined one or more dimensions of the space and the determined one or more dimensions of the first object, which may include generating a second image portraying a representation of the space and the first object located in the representation of the space.

The present disclosure also describes various example devices. Example devices may include a processor, and one or more machine readable medium having instructions stored therein, which when executed by the processor cause the apparatus to provide an indication of whether a first object will fit within a space by determining one or more dimensions of the space, receiving a first image portraying the first object, determining one or more dimensions of the first object, and providing an indication of whether the first object will fit within the space based at least in part on the determined one or more dimensions of the space and the determined one or more dimensions of the first object.

Additionally, the present disclosure describes various example computer readable medium. Example computer readable medium may have instructions non-transitorily stored therein, which when executed by one or more processors, cause a computer to determine one or more dimensions of a space, receive a first image portraying a first object, determine one or more dimensions of the first object, and provide an indication of whether the first object will fit within the space based at least in part on the determined one or more dimensions of the space and the determined one or more dimensions of the first object.

The foregoing summary is illustrative only and not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Various examples, embodiments, and implementations of the present disclosure will be described by way of reference to the accompanying drawings, understanding that these drawings depict only several embodiments in accordance with the disclosure, and are therefore, not to be considered limiting of its scope.

In the drawings:

FIG. 1 illustrates a block diagram of a cell phone 100 configured to determine dimensions of a space and/or object and generate a visual representation of the space;

FIG. 2 illustrates a block diagram of a method for determining dimensions of a space and/or object and generate a visual representation of the space;

FIG. 3 illustrates an example image portraying a space;

FIG. 4 illustrates another example image portraying the space shown in FIG. 3;

FIG. 5 illustrates an example image portraying an object; and

FIG. 6 illustrates an example image portraying the space illustrated in FIGS. 3 and 4 and the object illustrated in FIG. 5;

FIG. 7 illustrates an example image portraying the image of FIG. 6 in alternate detail, all arranged in accordance with at least some embodiments of the present disclosure.

### DETAILED DESCRIPTION

The following description sets forth various examples along with specific details to provide a thorough understanding of the claimed subject matter. It will be understood by those skilled in the art that the claimed subject matter might be practiced without some or more of the specific details disclosed herein. Further, in some circumstances, well-known methods, procedures, systems, components and/or circuits have not been described in detail, in order to avoid unnecessarily obscuring the claimed subject matter.

In the following detailed description, reference is made to the accompanying drawings, which form a part hereof. In the drawings, similar symbols typically identify similar components, unless context dictates otherwise. Furthermore, various items depicted in the drawings may not necessarily be to scale, unless specified herein. The figures are presented for example and illustration to complement the present disclosure and should not be taken as limiting.

The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

As indicated above, in various embodiments of the present disclosure, dimensions of a space and/or objects may be determined from images (e.g., photographs, or the like) of the space and/or objects. Additionally, in some embodiments, a visual representation of a space including some objects that may not be currently present in the space may be generated. For example, a tablet computer may be used to capture an image of a dining room and a dining table set. Then, a visual representation of the dining table set in the dining room may be generated. Furthermore, one or more dimensions of the dining room and/or dining table set may be determined as part of the visual representation. Additionally, it may be determined if there is sufficient space in the dining room to fit the dining table set. This example is given for illustrative purposes only and is not intended to be limiting. Other examples and implementations will be apparent from the present disclosure.

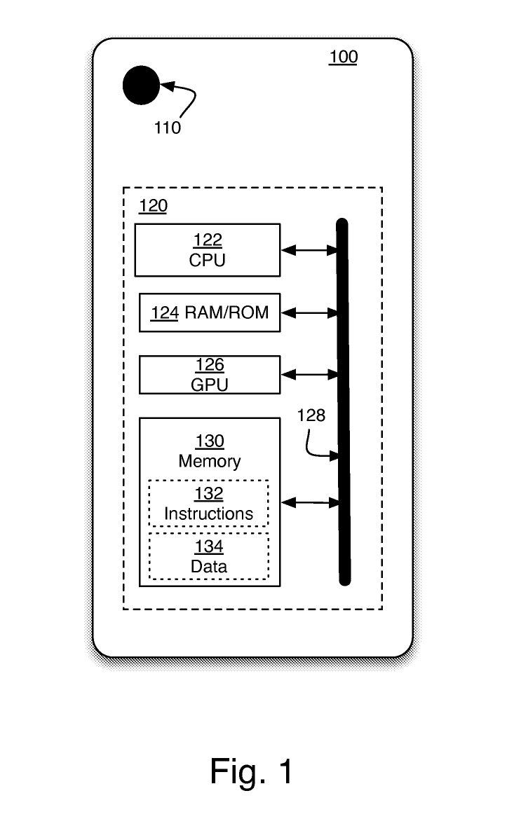

FIG. 1 illustrates a block diagram of a cell phone 100 configured to determine dimensions of a space and/or object and generate a visual representation of the space including some object that may not be in the space, arranged in accordance with various embodiments of the present disclosure. It is to be appreciated, that although various examples disclosed herein reference FIG. 1 and a cell phone, that other devices (e.g., a tablet computer, a digital camera, a computer system, or the like) may be configured to implement various embodiments of the present disclosure. Furthermore, although the cell phone 100 is shown having a camera 110, various embodiments of the present disclosure may be implemented by devices that do not have a camera. More particularly, images may be captured on one device or accessed from a resource (e.g., the Internet) and then another device (e.g., a computer system) may be used to implement various embodiments of the present disclosure.

The cell phone 100 is further shown having computing logic 120. Computing logic 120 includes a central processing unit (CPU) 122, operating memory (RAM/ROM) 124, and a graphics processing unit (GPU) 126, all connected via a bus 128. In addition, although not shown, the camera 110 may be connected to the computing logic 120 via the bus 128. The computing logic 120 may also include memory 130. Memory 130 may be any type of computer-readable medium (e.g., flash memory, spinning media, or the like). In general, the memory 130 may be configured to store instructions 132 and data 134 that allow the cell phone 100 to implement various embodiments of the present disclosure.

For example, the memory 130 may store instructions 132 that when executed by the CPU 122 cause the cell phone 100 to determine one or more dimensions of a space represented in a picture taken by the camera 110 and stored as data 134. As indicated, although reference is often made herein to the cell phone 100, other devices may be used to implement various embodiments of the present disclosure. For example, a picture could be taken by the cell phone 100, then uploaded to a cloud based storage provider (e.g., using a cellular radio, using a Wi-Fi radio, or the like) and the cloud based storage provider may include logic and/or features configured to implement various embodiments of the present disclosure using the uploaded picture.

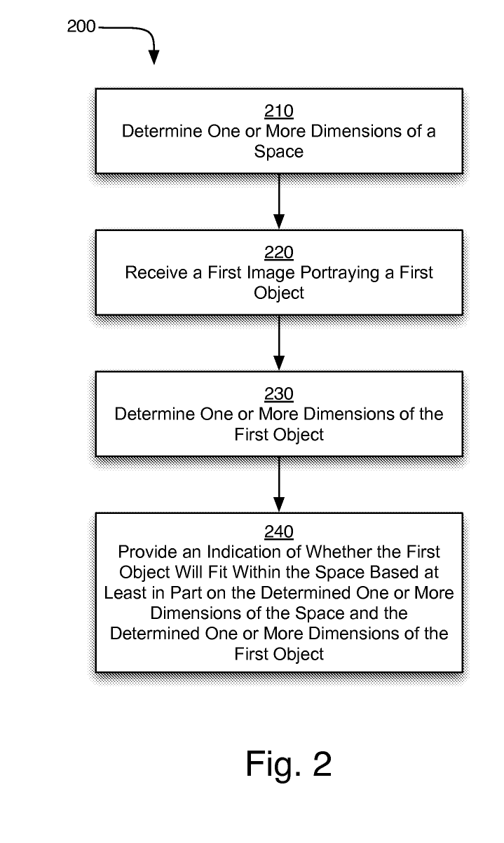

FIG. 2 illustrates a block diagram of a method 200, arranged in accordance with various embodiments of the present disclosure. In some portions of the description, illustrative implementations of the method 200 may be described with reference to the elements of the cell phone 100 of FIG. 1. However, the described embodiments are not limited in these respects. That is some elements shown in FIG. 1 may be omitted from example implementations of the methods detailed herein. Furthermore, other elements not depicted in FIG. 1 may be used to implement example methods.

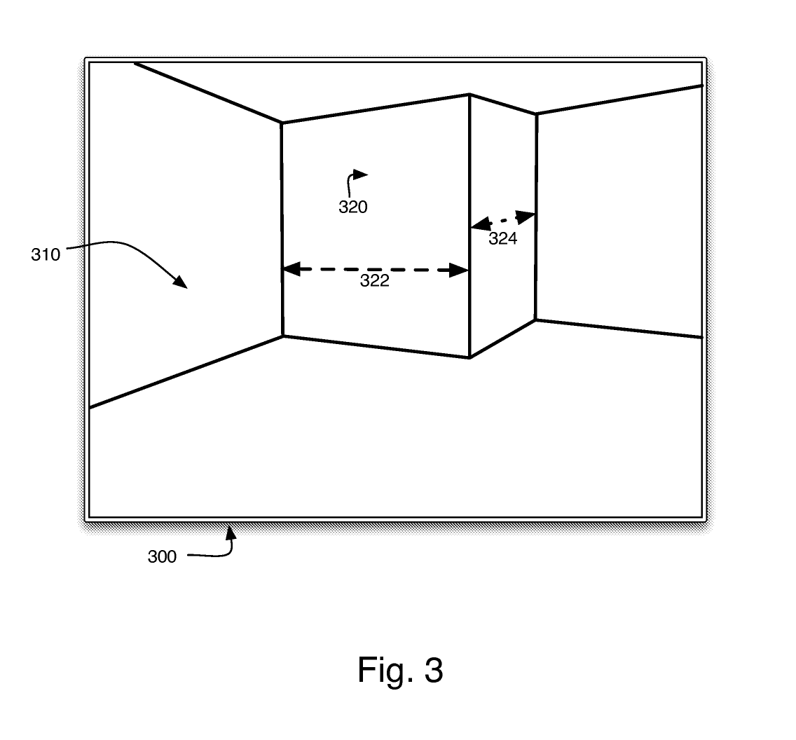

Additionally, the method 200 is described with reference to various images. FIGS. 3-7 illustrates example images including a space and/or objects. In some portions of the description, reference is made to one or more of FIGS. 3-7. However, the described embodiments are not limited to these depictions and may be applied to other pictures different than those shown here. Furthermore, it is to be appreciated, that the images depicted in FIGS. 3-7 are made for ease of presentation and are not intended to be to scale, to include all features that may normally be present in an image, or the like.

The method 200 may begin at block 210 (“Determine one or more dimensions of a space”). In general, at block 210, the cell phone 100 may include logic and/or features (e.g., the computing logic 120, or the like) configured to determine one or more dimensions of a space. FIG. 3 illustrates an example image 300 portraying a space 310 having a wall 320. Dimensions (e.g., wall width 322 and wall width 324) of the space 310 are also shown in FIG. 3. As will be appreciated, the dotted lines may not be physically present in the space 310, but rather are an indication of the extent of the dimensions of the wall 320.

In some embodiments, the dotted lines corresponding to wall widths 322 and/or 324 may be drawn in at block 210. For example, a user may take a picture of the space 310 on the cell phone 100 and the image 300 including the wall widths 322 and 324 may be generated and portrayed on a display of the cell phone 100. With some embodiments, an image (e.g., the image 300, or the like) may be received at block 210, then one or more dimensions of the space 310 portrayed in the image may be determined. As will be appreciated, other dimensions (e.g., those not shown in FIG. 3) may also be determined. For example, other wall dimensions, square footage of the floor, area of the space 310, or the like, may be determined at block 210.

Prior to determining the dimensions and position of the wall 320, it may be necessary to identify the existence of the wall 320. In some embodiments, a walls existence may be identified by examining features including edges, contrast, histograms, model databases, feature extraction, scene modeling, user input, and any other features.

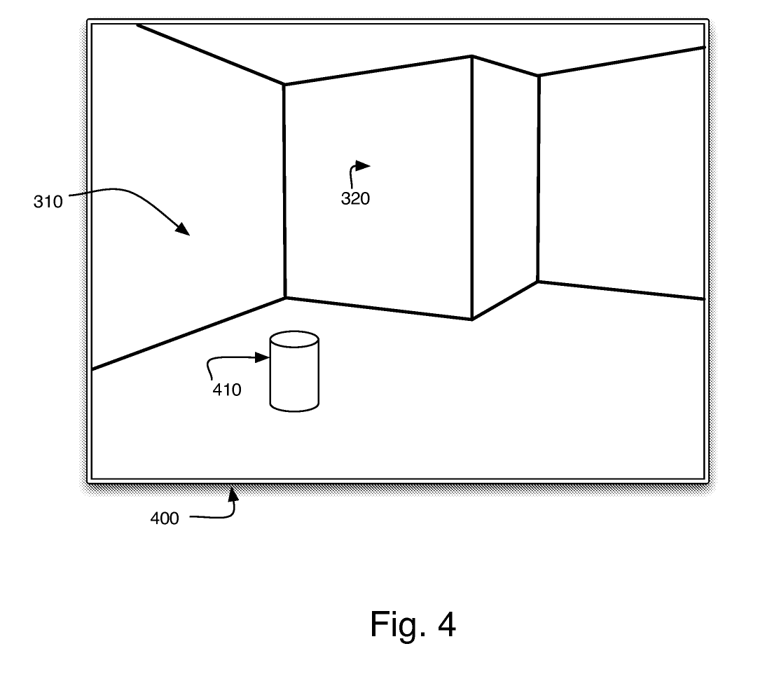

Subsequently, wall width 322 and wall width 324 may be determined by comparing an object within the space 310, which has known dimensions, to the overall space 310. FIG. 4 illustrates an example image 400 portraying the space 310 and the wall 320. Furthermore, the image 400 portrays an object 410. As shown here, the object 410 may be a cylinder, and may have known diameter and height. As a result, one or more dimensions of the wall 420 may be determined from the known dimensions of the object 410.

In some examples, the object 410 may be a variety of different objects. For example, the object 410 may be a coin, which may have known dimensions. In some examples, the object may be a can of soda, a pencil, a sheet of paper, a tennis ball, or any of a variety of different objects, which may also have known dimensions. In some embodiments, the image 400 may portray multiple objects in the image. Accordingly, at block 210, a one of these multiple objects may be selected and then used to determine the dimensions of the space 310.

As will be appreciated, it may be advantageous to select a commonly sized object, a commonly available object, or a sufficiently easily identifiable object. This may allow a user to find the item on site without depending on the user to carry around known objects. For example, many people carry coins and coin dimensions are well known. Accordingly, a user may place a coin in a room to provide an object with known dimensions in the context of the room to be measured. Subsequently, an image of the room including the object (e.g., the image 400) may be captured using the camera 110.

The object 410 may be recognized by a variety of factors. In some examples, object recognition may be done by examining features including edges, contrast, histograms, model databases, feature extraction, scene modeling, user input, and any other features.

As indicated, dimensions of the space 310 may be determined based in part on the dimensions of the object 410. For example, due to changes in the perspective between the object 410 and the wall 420, the apparent diameter and height of the example object 410 may change. The object 410 may appear larger when closer to the camera, and may appear smaller when further away from the camera. The top surface of object 410 may also change in perspective as viewing angles change. Therefore, knowing the actual dimensions of object 410 and the appearance of object 410 within photo 400 may permit determination of the location and orientation of object 410 within the room. Further, knowing the dimensions of the object 410 may provide enough information to accurately calculate dimensions including wall width 322 and wall width 324.

Dimensions can be calculated to greater or lesser accuracy in part by using better computer models of the space. In one example, a computer model may account for vanishing point convergence of parallel walls to provide better determinations of wall widths. In one example, a computer model may determine a single dimension, such as wall height, and apply that dimension to other detected walls to provide known information to improve further calculations of other dimensions.

With some embodiments, various assumptions, for example, about building patterns, or the like, may be made as part of determining the dimensions of the space. For example, it may be assumed that the walls (e.g. the wall 320) is perpendicular to the floor and/or the roof. In some examples, walls are assumed to be perpendicular to each other. In some examples, windows are assumed to be square. In some examples, windows, shelves, tables, and any other detectable extents are assumed to be level. In some examples, no assumptions are necessary to determine dimensions.

In some examples, relative units can be determined without providing actual units of measurement. In some examples, one or more dimensions of known features may be added by a user and other dimensions may be determined in relation to the user provided dimensions.

In some examples, dimensions may be calculated without the use of a known object, such as object 410. For example, a database of known spaces and dimensions may be stored in the memory 130 (or other computer readable media accessible by the cell phone 100). Accordingly, at block 210, the cell phone may access the database to determine one or more dimension of a space by identifying a space in the database and identifying any associated dimension of the space. In some embodiments, this may be facilitated by receiving a selection of which space to choose from a user of the cell phone 100. For example, a user may have stored dimensions for their bedroom, bathroom, kitchen, family room, and dining room in the memory 130. Subsequently, at block 210, the user may select one of these room (e.g., the family room) and the cell phone may determine the dimensions of the space as those dimensions that correspond to the family room as stored in the memory 130. In some embodiments, dimensions for a space (e.g., the space 310) may be determined as detailed above, then stored in the memory 130 for later use.

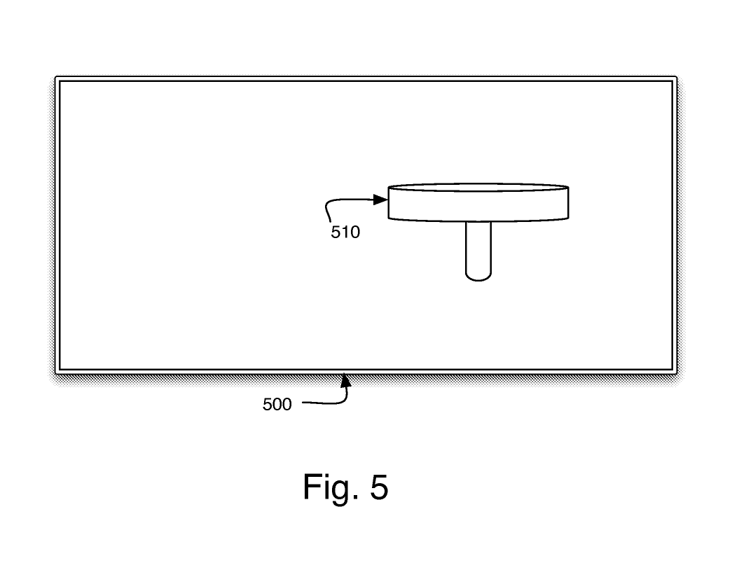

Continuing from block 210 to block 220 (“Receive a First Image Portraying a First Object”), the cell phone 100 may include logic and/or features configured to receive a first image portraying a first object. In some embodiments, the cell phone may receive the image by capturing the image using the camera 110. FIG. 5 illustrates an example image 500 portraying a first object 510. With some example, the image may be stored as data 134 in the memory 130. Accordingly, the cell phone 100 may access the memory 130 at block 220 to receive the image. Still, with some embodiments, the cell phone 100 may receive an image from another source. For example, an image located on the Internet may be received by the cell phone 100 by accessing the Internet using a network resource (e.g., cellular radio, Wi-Fi radio, or the like) and receiving the image from a server on the Internet.

Continuing from block 220 to block 230 (“Determine One or More Dimensions of the First Object”), the cell phone 100 may include logic and/or features configured to determine one or more dimensions of the first object 510. In general, at block 230, the processing logic 120 may recognize the first object 510. For example, the processing logic 120 may use object recognition techniques. In some examples, the processing logic 120 may recognize the first object 510 from a database of known objects. For example, the processing logic 120 may identify various characteristics of the first object 510 and then match the characteristics to objects in the database. In some example, a user may specify the type or class of object to which the first object 510 belongs. For example, if the object were a particular couch, the user may select the class (e.g., furniture, couches, or the like) of the object. Additionally, a user may specify the manufacturer or model. Alternatively, the processing logic 120 may identify the class, manufacturer, model, or the like from the image 500.

In some embodiments, the dimensions of the object 510 may be identified using similar techniques as detailed above. For example, an object having known dimensions (e.g., a coin, a soda can, or the like) may be identified in the image and then used to determine the dimensions of the object 510. With some examples, the determination of dimensions of the object 304 may be stored to the memory 130. With further examples, the dimensions of the object as well as a copy of the object 510 from the image 500 may be saved to the memory 130.

In some embodiments, the images (e.g., the image 500, or the like) may be acquired from any type of camera, including a camera that can change the plane of focus. For example, a camera may include rangefinder type depth detection. Accordingly, the image may be analyzed for greatest local contrast to determine the plane of focus. The camera may be configured to sweep through the focal range, gathering data on which portions of the image are in which focal planes. This information may then be used to determine distances of features from the camera, which may in turn be used to determine dimensions and areas of objects and/or spaces portrayed in the image.

With some embodiments, the images (e.g., the image 400, or the like) may be a 3D image of a space, captured by a camera configured to take 3D photos. In some examples, a 3D camera may have two or more lenses to provide a stereoscopic image or images. In some examples, multiple photos taken from different perspectives can be analyzed together to determine 3D characteristics, even if a composite 3D image is not generated. In some examples, a single camera may be used from multiple locations to take a 3D image or images. Dimensions and areas can be determined from the 3D image.

Combinations of the above techniques may provide for improved speed or accuracy. In some examples, dimensions may be determined by combining comparison of objects, improved modeling of the spaces, autofocus dimensioning, 3D stereoscopy, and/or user provided dimensions.

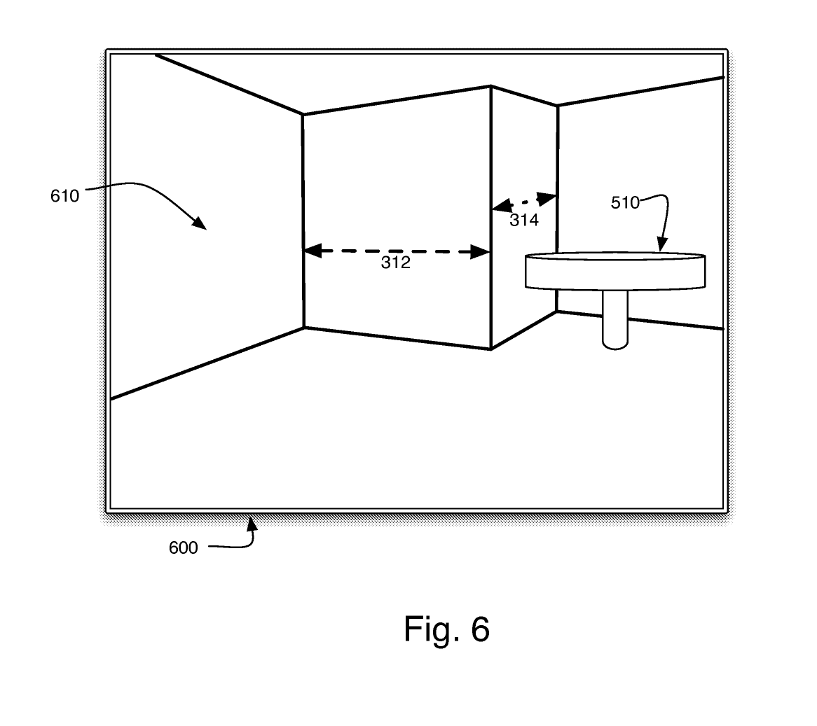

Continuing from block 230 to block 240 (“Provide an Indication of Whether the First Object Will Fit Within the Space Based at Least in Part on the Determined One or More Dimensions of the Space and the Determined One or More Dimensions of the First Object”), the cell phone 100 may include logic and/or features configured to provide an indication of whether the object 510 may fit within the space 310. In some embodiments, at block 240, processing logic 120 may provide an indication (e.g., a voice notification, a text notification, or the like) specifying whether there is sufficient room to fit the object 510 within the space 310. With some embodiments, processing logic 120 may generate an image representing the space 310 that includes the object 510. FIG. 6 illustrates an example image 600 that portrays a representation 610 of the space 310, including dimensions 322 and 324. Furthermore, as can be seen, the object 510 is depicted in the image 600. Specifically, the object 510 is portrayed within the representation 610.

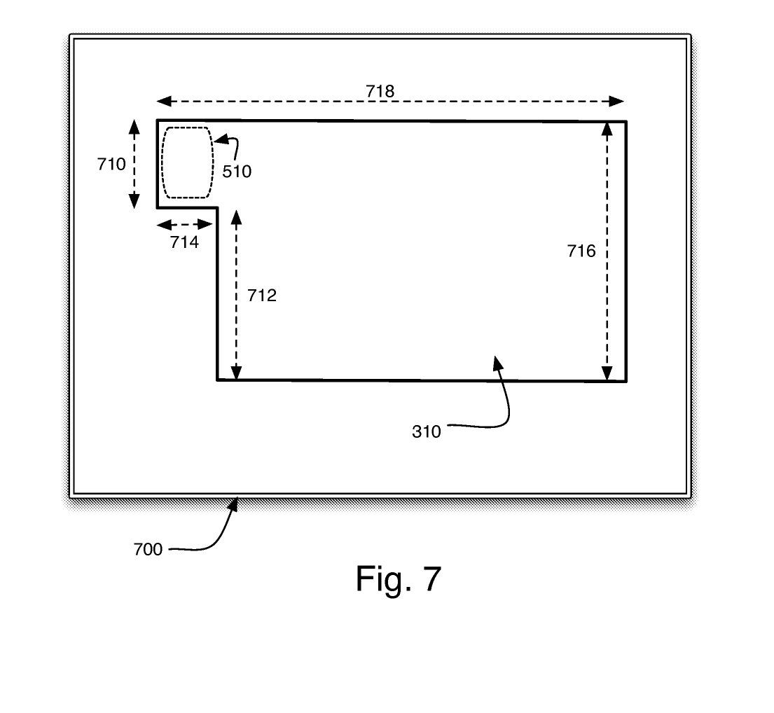

With some embodiments, an alternate view of the space 310 may be generated at block 240. FIG. 7 illustrates an example image 700 showing an overhead (e.g., floor plan, or the like) view of the space 310. As can be seen, the various dimensions 710, 712, 714, 716, and 718 are also shown in the image 700. In some embodiments, an overhead view may provide a better aspect to determine if an object (e.g., the object 510, or the like) fits within a given space, or a selected portion of a given space.

As indicated above, with some embodiments, many spaces and objects may be photographed and dimensioned and stored in the memory 130. With various embodiments, these images can be put together in a composite image to provide an estimated appearance of one or more objects in a room and to determine the fit of the objects within the room.

What is claimed:

1. A computer-implemented method comprising:
determining one or more dimensions of a space;
receiving a first image portraying a first object;
determining one or more dimensions of the first object; and
providing an indication of whether the first object will fit within the space based at least in part on the determined one or more dimensions of the space and the determined one or more dimensions of the first object.

2. The computer-implemented method of claim 1, wherein providing an indication of whether the first object will fit within the space comprises generating a second image portraying a representation of the space and the first object located in the representation of the space.

3. The computer-implemented method of claim 1, wherein determining one or more dimensions of the space comprises:
receiving a second image portraying the space; and
determining the one or more dimensions of the space based at least in part on the received second image.

4. The computer-implemented method of claim 3, wherein determining the one or more dimensions of the space based at least in part on the received second image comprises:
determining a location of the space;
accessing a lookup table of known spaces, dimensions, and locations;
identifying a known space in the lookup table substantially matching the determined location; and
associating one or more dimensions in the lookup table corresponding to the identified known space within the space.

5. The computer-implemented method of claim 3, wherein the second image portrays a second object being located in the space and determining the one or more dimensions of the space based at least in part on the received second image comprises:
determining one or more dimensions of the second object;
determining a position and/or orientation of the second object within the space; and
determining one or more dimensions of the space based at least in part on the determined position and/or orientation of the second object and the determined one or more dimensions of the second object.

6. The computer-implemented method of claim 1, further comprising:
receiving a second image portraying the space; and
generating a third image by overlaying at least a portion of the second image with at least a portion of the first image, wherein the portion of the first image includes the first object.

7. The computer-implemented method of claim 1, wherein determining one or more dimensions of the first object comprises:
determining a class of the first object; and
determining one or more dimension of the first object based at least in part on the determined class.

8. The computer-implemented method of claim 7, wherein determining a class of the first object comprises:
determining one or more characteristics of the first object; and
identifying the class of the first object based at least in part on the determined one or more characteristics of the first object.

9. The computer-implemented method of claim 8, wherein identifying the class of the first object based at least in part on the determined one or more characteristics of the first object comprises:
accessing a database of classes and class characteristics; and
identifying a class in the database that substantially includes the determined one or more characteristics.

10. The computer-implemented method of claim 1, wherein the first image further portrays a second object having one or more known dimensions and determining one or more dimensions of the first object comprises:
determining a position and/or orientation of the first object relative to the second object; and
determining one or more dimensions of the first object based at least in part on the determined position and/or orientations of the first object relative to the second object and the one or more known dimensions of the second object.

11. An apparatus comprising:
a processor; and
one or more machine readable medium having instructions stored therein, which when executed by the processor cause the apparatus to provide an indication of whether a first object will fit within a space by:
determining one or more dimensions of the space;
receiving a first image portraying the first object;
determining one or more dimensions of the first object; and
providing an indication of whether the first object will fit within the space based at least in part on the determined one or more dimensions of the space and the determined one or more dimensions of the first object.

12. The apparatus of claim 11, wherein providing an indication of whether the first object will fit within the space comprises generating a second image portraying a representation of the space and the first object located in the representation of the space.

13. The apparatus of claim 11, wherein determining one or more dimensions of the space comprises:
receiving a second image portraying the space; and
determining the one or more dimensions of the space based at least in part on the received second image.

14. The apparatus of claim 11, further comprising:
receiving a second image portraying the space; and
generating a third image by overlaying at least a portion of the second image with at least a portion of the first image, wherein the portion of the first image includes the first object.

15. The apparatus of claim 11, wherein determining one or more dimensions of the first object comprises:
determining a class of the first object; and
determining one or more dimension of the first object based at least in part on the determined class.

16. A machine-readable non-transitory medium having instructions stored therein which, when executed by one or more processors, cause a computer to:
determine one or more dimensions of a space;
receive a first image portraying a first object;
determine one or more dimensions of the first object; and
provide an indication of whether the first object will fit within the space based at least in part on the determined one or more dimensions of the space and the determined one or more dimensions of the first object.

17. The machine-readable non-transitory medium of claim 16, wherein providing an indication of whether the first object will fit within the space comprises generating a second image portraying a representation of the space and the first object located in the representation of the space.

18. The machine-readable non-transitory medium of claim 1, wherein determining one or more dimensions of the space comprises:
receiving a second image portraying the space; and
determining the one or more dimensions of the space based at least in part on the received second image.

19. The machine-readable non-transitory medium of claim 18, wherein the second image portrays a second object being located in the space and determining the one or more dimensions of the space based at least in part on the received second image comprises:
determining one or more dimensions of the second object;
determining a position and/or orientation of the second object within the space; and
determining one or more dimensions of the space based at least in part on the determined position and/or orientation of the second object and the determined one or more dimensions of the second object.

20. The machine-readable non-transitory medium of claim 16, further comprising:
receiving a second image portraying the space; and
generating a third image by overlaying at least a portion of the second image with at least a portion of the first image, wherein the portion of the first image includes the first object.
